(19) United States
(12) Patent Application Publication
(10) Pub. No.: US 2019/0339783 A1
(43) Pub. Date: Nov. 7, 2019

(54) TACTILE SENSATION PRESENTING DEVICE

(71) Applicant: ALPS ALPINE CO., LTD., Tokyo (JP)

(72) Inventors: Kunio SATO, Miyagi (JP); Daisuke TAKAI, Miyagi (JP); Yuzuru KAWANA, Miyagi (JP)

(21) Appl. No.: 16/517,836

(22) Filed: Jul. 22, 2019

Related U.S. Application Data
(63) Continuation of application No. PCT/JP2018/002019, filed on Jan. 23, 2018.

(30) Foreign Application Priority Data
Feb. 6, 2017 (JP) 2017-019196

(51) Int. Cl. G06F 3/01; G06F 3/044; G06F 3/045

(52) U.S. Cl. CPC G06F 3/016; G06F 3/045; G06F 3/044

(57) ABSTRACT

A tactile sensation presenting device includes: a vibrating element configured to present vibration information; a warmth/coldness presenting element provided above the vibrating element and configured to present warm/cold information to a tactile sensation presentation surface; a pressure detecting unit configured to detect a pressure corresponding to a contact state of an operating part with respect to the tactile sensation presentation surface; and an adjusting unit configured to adjust a presentation condition based on a detection result by the pressure detecting unit.

### CROSS-REFERENCE TO RELATED APPLICATIONS

This application is a continuation of International Application No. PCT/JP2018/002019, filed on Jan. 23, 2018 and designated the U.S., which claims priority to Japanese Patent Application 2017-019196, filed on Feb. 6, 2017. The contents of these applications are incorporated herein by reference in their entirety.

### BACKGROUND OF THE INVENTION

### 1. Field of the Invention

The present invention relates to a tactile sensation presenting device for presenting warm/cold information and vibration information when touched by an operating part such as a finger.

### 2. Description of the Related Art

Patent Document 1 describes a device in which a tactile sensation presenting device that generates vibration by a voice coil, a piezoelectric element, or the like, a Peltier element that presents a warm sensation, and a sensor that measures a temperature of skin are disposed on a base. The tactile sensation presenting device and the sensor are directly disposed on the base, and the Peltier element is disposed on the tactile sensation presenting device. According to this configuration, not only vibration but also an effect of temperature can be provided when a tactile sensation is presented. Thus, a tactile sensation transmitting device having higher expressiveness can be realized.

### RELATED-ART DOCUMENTS

[Patent Document 1] Japanese Laid-open Patent Publication No. H07-072018

However, even when a same vibration or temperature is presented, depending on the difference of a contact state of an operator's hand with respect to a device, the operator feels a deferent tactile sensation. Therefore, it is difficult to realistically conduct an intended tactile sensation.

Accordingly, an object of the present invention is to provide a tactile sensation presenting device that can adjust a presented tactile sensation in accordance with a contact state of an operating part with respect to a tactile sensation presentation surface, where a tactile sensation is presented, so as to be able to provide a more realistic tactile sensation.

### SUMMARY OF THE INVENTION

In order to solve the above described problem, a tactile sensation presenting device according to an aspect of the present invention includes: a vibrating element configured to present vibration information; a warmth/coldness presenting element provided above the vibrating element and configured to present warm/cold information to a tactile sensation presentation surface; a pressure detecting unit configured to detect a pressure corresponding to a contact state of an operating part with respect to the tactile sensation presentation surface; and an adjusting unit configured to adjust a presentation condition based on a detection result by the pressure detecting unit.

Thereby, it is possible to adjust, in accordance with the contact state of the operating part with respect to the tactile sensation presentation surface, the presented tactile sensation, and it is possible to provide a more realistic tactile sensation. For example, when the contact pressure is lower than a reference value, vibration information and/or warm/cold information stronger than usual is provided or the contact pressure is controlled to be increased. Also, when the contact pressure is higher than the reference value, weak vibration information and/or weak warm/cold information is provided or the contact pressure is controlled to be lowered. Thereby, it is possible to present a constant tactile sensation as intended, regardless of the contact state of an operating part.

In the tactile sensation presenting device according to an aspect of the present invention, it is preferable that the adjusting unit adjusts at least one of the vibration information and the warm/cold information as the presentation condition.

Thereby, in accordance with the contact state of the operating part with respect to the tactile sensation presentation surface, it is possible to correct the vibration information and the warm/cold information, which contributes to presentation of a realistic tactile sensation.

In the tactile sensation presenting device according to an aspect of the present invention, the pressure detecting unit is provided on the tactile sensation presentation surface and detects the pressure received by the tactile sensation presentation surface from the operating part.

Thereby, it is possible to accurately detect the contact state of the operating part with respect to the tactile sensation presentation surface.

In the tactile sensation presenting device according to an aspect of the present invention, it is preferable that the tactile sensation presenting device includes a holding member configured to hold the operating part so as to maintain the contact state with respect to the tactile sensation presentation surface, and the pressure detecting unit is provided on a contact surface where the holding member contacts the operating part, and detects the pressure received by the contact surface from the operating part.

Thereby, because the contact state with respect to the tactile sensation presentation surface can be certainly maintained even after adjustment by the adjusting unit, the presented tactile sensation can be transmitted to the operating part accurately and quickly.

In the tactile sensation presenting device according to an aspect of the present invention, it is preferable that the adjusting unit adjusts, as the presentation condition, a pressure applied to the operating part contacting the tactile sensation presentation surface.

Thereby, because it is possible to adjust the contact state of the operating part with respect to the tactile sensation presentation surface, it is possible to present a realistic tactile sensation.

In the tactile sensation presenting device according to an aspect of the present invention, it is preferable that the tactile sensation presenting device includes a holding member configured to hold the operating part so as to maintain the contact state with respect to the tactile sensation presentation surface; and a displacing unit configured to displace the tactile sensation presentation surface, and the adjusting unit causes the displacing unit to displace the tactile sensation presentation surface based on the detection result by the pressure detecting unit in order to adjust the pressure applied to the operating part held by the holding member.

Thereby, because it is possible to adjust the contact state of the operating part by displacement of the tactile sensation presentation surface, it is possible to present a realistic tactile sensation.

In the tactile sensation presenting device according to an aspect of the present invention, it is preferable that the pressure detecting unit is an electrostatic detecting unit configured to detect the pressure by a change in electrostatic capacity.

Thereby, it is possible to realize a high-precision pressure detecting unit while reducing the size and cost.

In the tactile sensation presenting device according to an aspect of the present invention, it is preferable that the pressure detecting unit is a resistance type detecting unit configured to detect the pressure by a change in resistance value.

Thereby, because a load level actually applied can be detected, the noise resistance is excellent when detecting pressure. Further, because of a simple configuration, implementation is easy.

According to an aspect of the present invention, it is possible to adjust a presented tactile sensation in accordance with a contact state of an operating part with respect to a tactile sensation presentation surface, and it is possible to provide a more realistic tactile sensation.

### BRIEF DESCRIPTION OF THE DRAWINGS

FIG. 1 is a side view illustrating a schematic configuration of a tactile sensation presenting device according to a first embodiment of the present invention;

FIG. 2 is a plan view of the tactile sensation presenting device that is illustrated in FIG. 1;

FIG. 3 is a perspective view illustrating the tactile sensation presenting device illustrated in FIG. 1 as seen from above;

FIG. 4 is a side view when a finger is in contact with a pressure detecting unit according to the first embodiment;

FIG. 5 is a functional block diagram of the tactile sensation presenting device according to the first embodiment;

FIG. 6 is a diagram illustrating an example of first use of an input device and a display device according to a second embodiment of the present invention;

FIG. 7 is a diagram illustrating an example of second use of input devices and a display device according to the second embodiment of the present invention;

FIG. 8A is a perspective view illustrating a configuration of the input device that is illustrated in FIG. 6 and FIG. 7;

FIG. 8B is a perspective view illustrating a configuration of the input device that is illustrated in FIG. 6 and FIG. 7;

FIG. 9 is an exploded perspective view illustrating a configuration of a tactile sensation presenting device in the input device illustrated in FIGS. 6 to 8; and

FIG. 10 is a functional block diagram of the tactile sensation presenting device that is illustrated in FIG. 9.

### DETAILED DESCRIPTION OF THE PREFERRED EMBODIMENTS

In the following, tactile sensation presenting devices according to embodiments of the present invention will be described in detail with reference to the drawings.

### First Embodiment

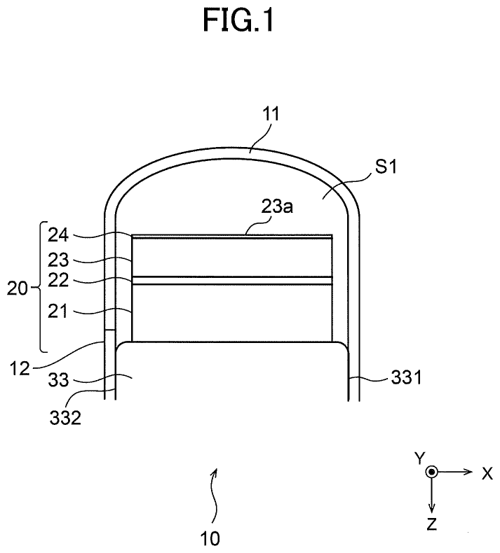

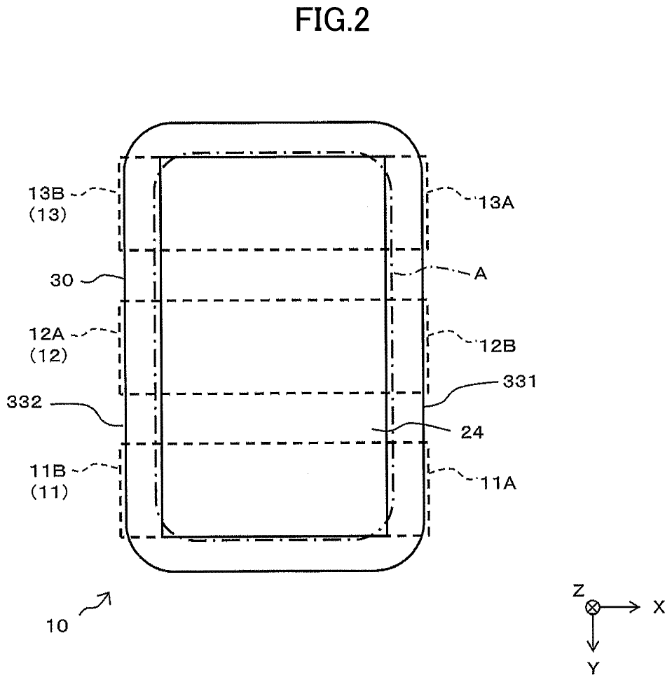

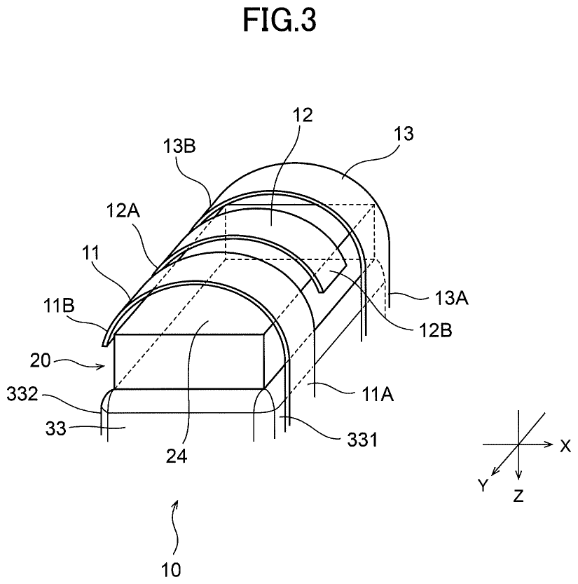

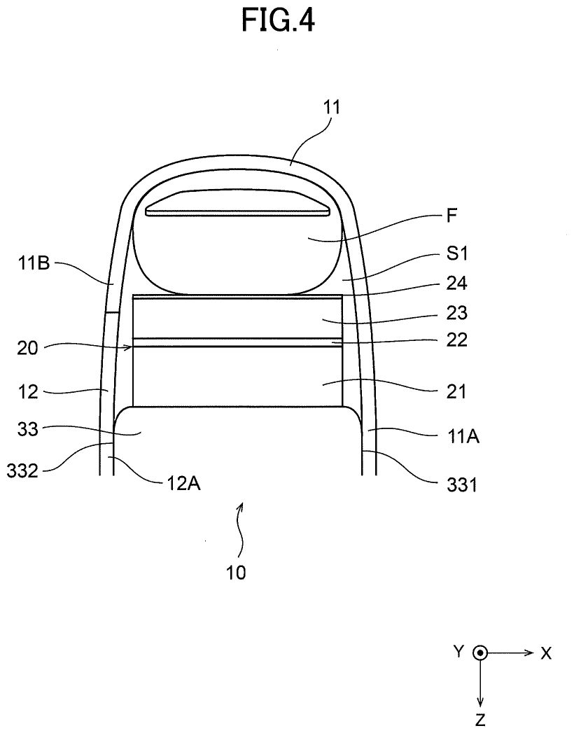

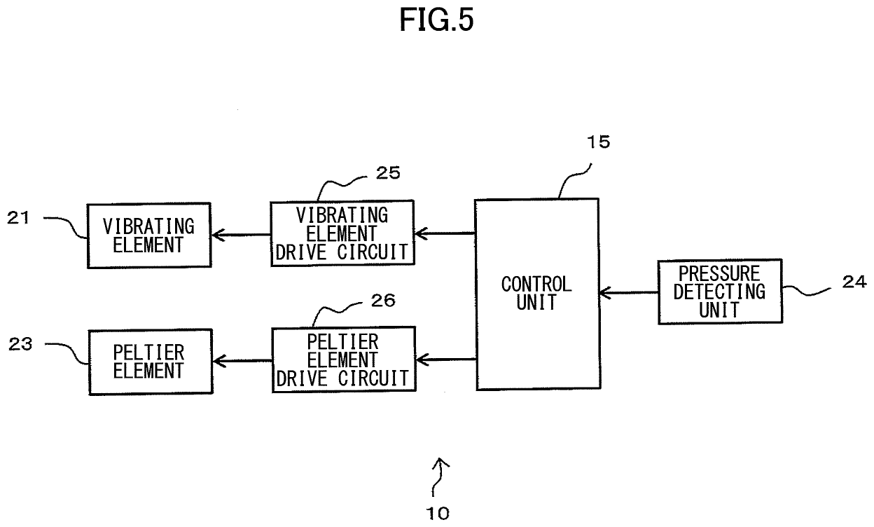

FIG. 1 is a side view illustrating a schematic configuration of a tactile sensation presenting device 10 according to a first embodiment; FIG. 2 is a plan view of the tactile sensation presenting device 10 that is illustrated in FIG. 1; FIG. 3 is a perspective view illustrating the tactile sensation presenting device 10 illustrated in FIG. 1 as seen from above; FIG. 4 is a side view when a finger F is in contact with a pressure detecting unit 24; and FIG. 5 is a functional block diagram of the tactile sensation presenting device 10. In FIG. 1 to FIG. 4, X-Y-Z coordinates are illustrated as reference coordinates. In the following description, a state viewed from the upper side to the lower side in the Z direction may be referred to as plan view, and the Z direction is a direction perpendicular to an X-Y plane. In FIG. 2, for the sake of description, holding members 11, 12, and 13 are illustrated by dashed lines.

The tactile sensation presenting device 10, as illustrated in FIG. 1, has a configuration in which a tactile sensation generating unit 20 is arranged on a support 33 and three holding members 11, 12, and 13 are provided on the support 33, as illustrated in FIG. 3.

As illustrated in FIG. 1, the tactile sensation generating unit 20 includes a vibrating element 21, a conductive member 22, a Peltier element 23, and a pressure detecting unit 24. The vibrating element 21 is placed on the support 33. Above the vibrating element 21, the Peltier element 23 as a warmth/coldness presenting element is placed via the conductive member 22. Further, the pressure detecting unit 24 is provided on the surface 23a of the Peltier element 23.

The three holding members 11, 12, and 13 maintain, by their elasticity, a contact state of a finger in contact with the pressure detecting unit 24 of the tactile sensation presenting unit 20. These holding members 11, 12, and 13 are sequentially arranged at a constant interval in the longitudinal direction (the Y direction illustrated) of the tactile sensation presenting unit 20 having a rectangular shape in plan view. Each of the holding members 11, 12, and 13 extends along the width direction (the X direction illustrated) of the tactile sensation generating unit 20 in a belt-like fashion. Each of one end portion 11A of the belt-like first holding member 11 and one end portion 13A of the belt-like third holding member 13 in its longitudinal direction is fixed to a side surface 331 of the support 33 by adhesion or the like. The first holding member 11 and the third holding member 13 bend and extend so as to protrude upward in the Z direction and form a space S1 (FIG. 1) with the pressure detecting unit 24 of the tactile sensation generating unit 20. Further, each of the other end portions 11B and 13B, which are tip portions, extends in the X direction to a side surface 332 opposite the side surface 331. Also, one end portion 12A of the belt-like second holding member 12 is fixed to the side surface 332. The second holding member 12 bends and extends so as to protrude upward in the Z direction and form the space S1 with the pressure detecting unit 24 of the tactile sensation generating unit 20. The other end portions 12B, which is a tip portion, extends to the side surface 331.

The three holding members 11, 12, and 13 are composed of an elastic material, such as a rubber material, a sponge material, or a spring material, for example. The three holding members 11, 12, and 13 have an elastic force so that when an operator's finger F is inserted into the space S1 between the holding members 11, 12, and 13 and the pressure detecting unit 24, the finger F is pressed from above toward the pressure detecting unit 24. Thereby, it is possible to ensure that the finger F and the pressure detecting unit 24 are in contact with each other, and it is possible to maintain the contact state. Further, it is possible to accurately and quickly transmit, to the finger F, a fine tactile sensation presented on the pressure detecting unit 24. Also, because the first holding member 11 and the third holding member 13 and the second holding member 12 are fixed to different sides surfaces of the support 33, the finger F can be restrained in a balanced manner. Further, because the holding members 11, 12, and 13 are arranged with an interval in the Y direction, a finger F is easily inserted into the space S1 between the holding members 11, 12, and 13 and the pressure detecting unit 24, and the feeling of pressure applied to the finger F can be reduced.

Note that the shapes, the number, and the arrangement of holding members are not limited to those illustrated in FIG. 1 to FIG. 4 as long as the holding members can maintain a contact state between a finger inserted in the space S1 and the pressure detecting unit 24.

The vibrating element 21 has a configuration in which, for example, a vibrator is supported by an elastic member such as a leaf spring in a metal case or cover so as to be able to vibrate freely. A coil is wound around the vibrator, and a magnet facing the coil is fixed in the case. When the control unit 15 (FIG. 5), which serves as a vibration control unit, applies, a control signal to the vibrating element drive circuit 25, the vibrating element drive circuit 25 applies, as a drive signal, an alternate current to the coil in the vibrating element 21. Thereby, the vibrator of the vibrating element 21 vibrates such that vibration information can be presented.

The vibrating element 21 may have a configuration in which a vibrator is formed of a magnet and a coil facing the vibrator is fixed in a case. Also, the vibrating element 21 may be a piezoelectric element that is configured to vibrate in accordance with a control signal from the control unit 15.

The conductive member 22 is, for example, an adhesive tape material, such as a double sided tape. The conductive member 22 is arranged to cover the upper surface of the vibrating element 21. By the adhesiveness of the conductive member 22, the conductive member 22 is fixed on the vibrating element 21 and the Peltier element is fixed on the conductive member 22. By the conductive member 22, the vibrating element 21 and the Peltier element 23 are coupled to each other.

The conductive member 22 serves as a thermally conductive member to conduct, to a metal case of the vibrating element 21, heat that is generated when the Peltier element 23 presents warm/cold information. Also, the conductive member 22 serves as a vibration conductive member to conduct, to the Peltier element 23, vibration information presented by the vibrating element 21.

In this manner, because the conductive member 22 has an adhesive property and a vibrational conductivity, the vibration information presented by the vibrating element 21 can be efficiently transmitted via the Peltier element 23 to the surface (upper side surface in the Z direction in FIG. 1) of the pressure detecting unit 24. Further, because the conductive member 22 has a thermal conductivity, heat generated by the Peltier element 23 can be diffused by itself. In addition, the heat can be efficiently conducted from the back surface (lower surface in the Z direction) of the Peltier element 23 particularly to the metal case of the vibrating element 21, and the heat dissipation efficiency can be enhanced by using the metal case as a heat sink.

For example, the Peltier element 23, which serves as a warmth/coldness presenting element, utilizes heat transfer of the Peltier effect that occurs when DC current is applied from a Peltier element drive circuit 26 (FIG. 5) to a junction of two metal plates facing each other in the Z direction, and the heat quantity on the surfaces of the two metal plates changes in accordance with a direction of the current. The current as a drive signal applied from the Peltier element drive circuit 26 to the Peltier element 23 is generated based on a control signal applied from the control unit 15. By controlling the direction and the amount of current applied to the Peltier element 23, it is possible to cause a finger touching the Peltier element 23 to sense a warm temperature or a cold temperature, and it is possible to present fine warm/cold information.

Here, as the warmth/coldness presenting element, other than the Peltier element, a thermoelectric element using the Thomson effect may be used. Alternatively, in place of the warmth/coldness presenting element, an element that presents warm information, such as a heater, may be used, for example.

As illustrated in FIG. 1, the pressure detecting unit 24 is fixed to the surface 23a of the Peltier element 23. The pressure detecting unit 24 has a thin structure so that heat of the Peltier element 23 can be transferred to a finger as an operating part.

The upper surface of the pressure detecting unit constitutes a tactile sensation presentation surface that is can be contacted by a finger as an operating part. The pressure detecting unit 24 includes a substrate of a resin film attached on the Peltier element 23. As the substrate of the resin film, a thin material is used to facilitate thermal conduction. The pressure detecting unit 24 is an electrostatic detecting unit and has a configuration in which two electrodes are provided to be arranged on the substrate so as to face each other in the vertical direction (Z direction). A finger as an operating part contacts the upper electrode that is the tactile sensation presentation surface. With respect to the pressure detecting unit 24, when a finger as an operating part contacts the upper electrode, the distance between the electrodes is changed by a contact pressure as a pressure corresponding to the contact state. In response to this change amount, the electrostatic capacity between the electrodes changes. The electrostatic capacity detected by the pressure detecting unit 24 is output to the control unit 15 (FIG. 5) and the change amount of the contact pressure of the finger is calculated based on the change amount of the electrostatic capacity.

Here, when a plurality of pairs of electrodes facing each other are arranged in the X-Y plane direction, they can also be used as a contact detecting unit of a mutual capacitive detecting type or a self-capacitive detecting type. In this case, by a change in the electrostatic capacity between an electrode and a finger that is an operating part, or a change in the electrostatic capacity between the plurality of electrodes, it is possible to detect that the finger has contacted the pressure detecting unit 24. Further, in a mutual capacitive detecting type, it is possible to detect which coordinate position of the pressure detecting unit 24 is touched by a finger, and it is possible to detect operation information including movement of a finger by detecting the contact position for every predetermined elapsed time.

The detection result by the pressure detecting unit 24 is output to the control unit 15, and the control unit 15 applies, based on the detection result, (1) a control signal to the vibrating element drive circuit 25 for presenting vibration information, and (2) a control signal to the Peltier element drive circuit 26 for presenting warm/cold information. Here, the control unit 15, which serves as an adjusting unit, adjusts, as a presentation condition of the tactile sensation, at least one of the vibration information and the warm/cold information based on the detection result by the pressure detecting unit 24. More specifically, the control unit 15 causes vibration information and warm/cold information to be differently presented for a case in which a contact pressure of a finger with respect to the pressure detecting unit 24 is within a predetermined range and for a case in which a contact pressure of a finger with respect to the pressure detecting unit 24 exceeds the predetermined range. Also, in a case in which the contact pressure is below the predetermined range, the control unit 15 may cause vibration information and warm/cold information, which are different from those of the case in which the contact pressure is within the predetermined range and those of the case in which the contact pressure exceeds the predetermined range, to be presented, or may alert the operator to increase the contact pressure. By such adjustments, it is possible to maintain a constant tactile sensation presented to an operator, even when the contact pressure differs. Alternatively, by changing the tactile sensation in accordance with the contact pressure, for example, it is possible to realistically present a virtual tactile sensation.

In a plan view as illustrated in FIG. 2, the area where the pressure detecting unit 24 is provided, that is, the outer shape of the tactile sensation presentation surface approximately matches the contact area A corresponding to an operation surface of a finger as an operating part. Here, the operation surface of the finger is the pad of the finger, and the contact area A corresponds to the area where the pad of the finger contacts the pressure detecting unit 24. It is most preferable that the size and the outer shape of the area where the pressure detecting unit 24 is provided are the same as those of the contact area A. However, the contact area A may be wider than the area of the pressure detecting unit 24, or the area of the pressure detecting unit 24 may be wider than the contact area A. Note that it is preferable that the area where a finger contacts the pressure detecting unit 24 is 50% or more.

Note that other than an electrostatic detector that detects an electrostatic capacity as described above, a pressure detecting unit may be, for example, a resistance type detector that detects a change in electrical resistance such as a strain gauge, a MEMS (Micro Electro Chemical System) sensor such as a diaphragm gauge, or a piezoelectric type detector using a piezoelectric element.

Here, in the electrostatic type pressure detection described above, in particular, detection can be performed with no load, and for example, in a case of being in touch with a finger, it is possible to detect a portion actually touched and a portion floating. Therefore, because it is possible to detect a wide range with high accuracy, it is possible to obtain a high level of contact distribution.

On the other hand, in the resistance type pressure detection, because a load level actually applied can be detected, the noise resistance is excellent, and a configuration is simpler than that of the electrostatic type, implementation is easy.

In addition, in a case where the tactile sensation generating unit 20 is configured to function as a pushbutton, upon the pushbutton being pushed, a switch or a sensor on the support 33 side may operate to detect that the pushbutton is pushed. In this case, the switch or the sensor on the support 33 side functions as a pressure detecting unit.

Other than a configuration provided on the Peltier element 23, the pressure detecting unit may be provided on an inner surface of the holding members 11, 12, and 13, that is, the pressure detecting unit may be provided on a contact surface that contacts a finger contacting the surface of the pressure detecting unit 24. Thereby, it is possible to detect a pressure received by the contact surface from the finger. This pressure corresponds to the contact pressure of the finger as an operating part contacting the tactile sensation presentation surface, and based on this detection result, it is possible to adjust the presentation condition of the tactile sensation.

Further, it is preferable to provide a temperature sensor in the pressure detecting unit 24 to measure a surface temperature of the Peltier element 23 to adjust, based on the difference between the measured temperature and a set temperature, a control signal that is applied to the Peltier element 23.

Also, the holding members 11, 12, and 13 may be omitted. In this case also, for example, in a case in which the contact pressure with respect to the tactile sensation generating unit 20 is increased or decreased due to the strength of a finger or hand, the thickness or hardness of a finger, or other factors, a tactile sensation in accordance with the contact pressure can be presented.

As described above, according to the tactile sensation presenting device 10 according to the first embodiment, it is possible to detect a contact pressure on the pressure detecting unit 24 as the tactile sensation presentation surface, and it is possible to provide, to a finger contacting the pressure detecting unit 24, information obtained by combining as desired vibration information and warm/cold information adjusted in accordance with the detected contact pressure. Thus, it is possible to present finer, complex, and realistic tactile sensations. Further, because the finger F is held by the holding members 11, 12, and 13 that are elastic, the vibration information and the warm/cold information adjusted in accordance with the contact pressure can be easily and certainly transmitted.

### Second Embodiment

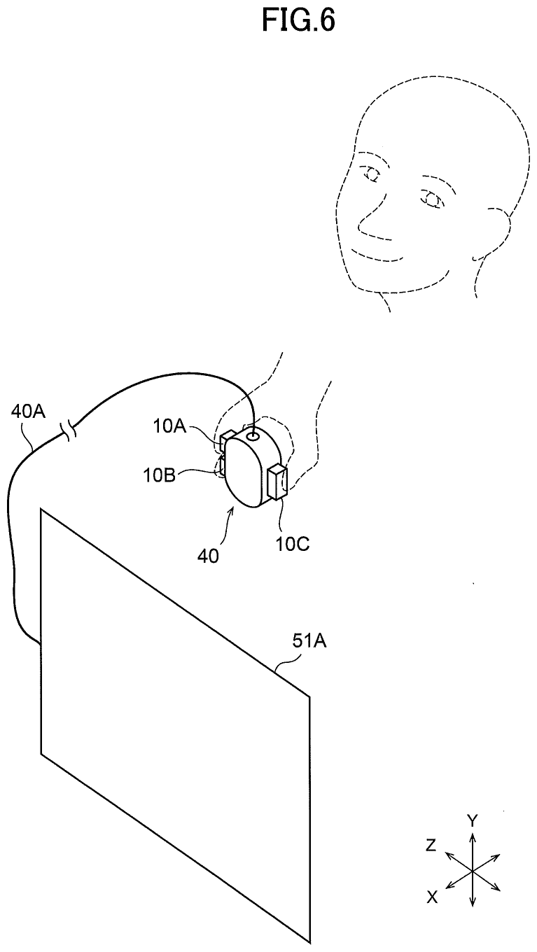

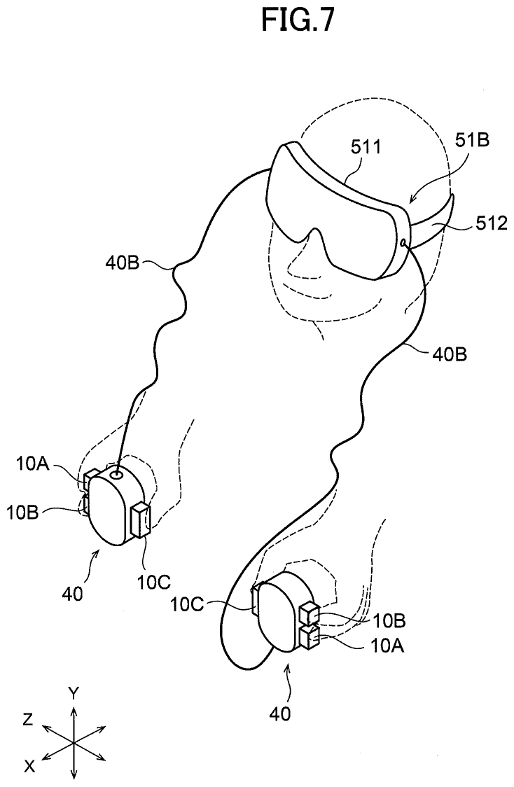

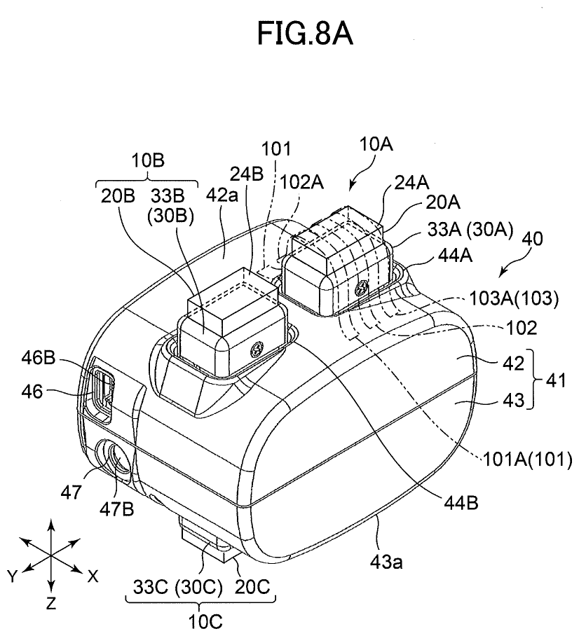

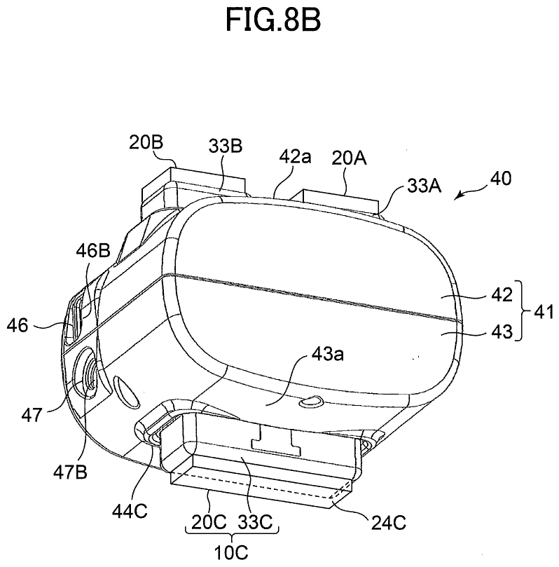

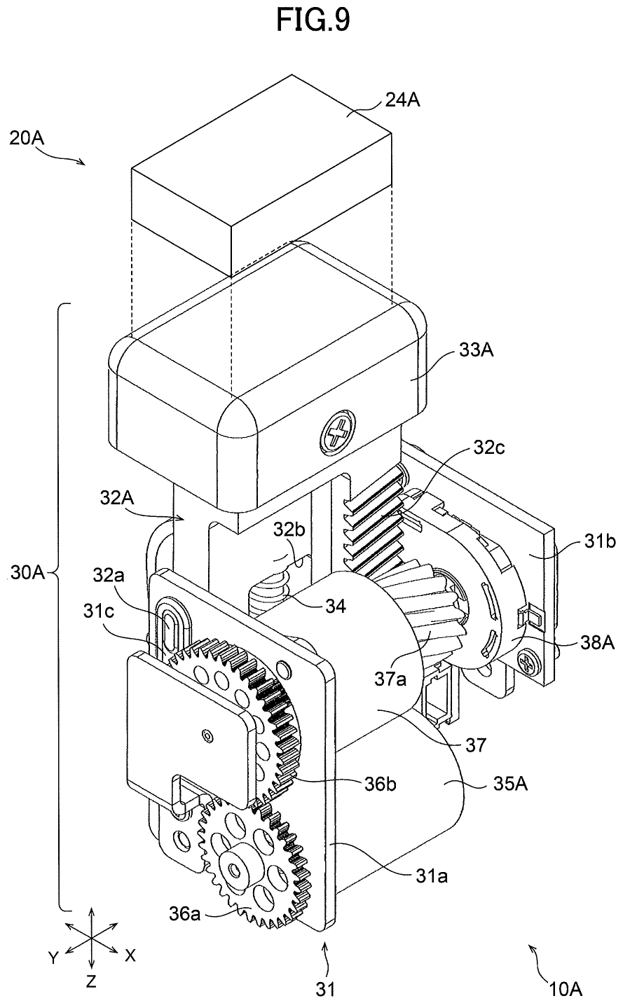

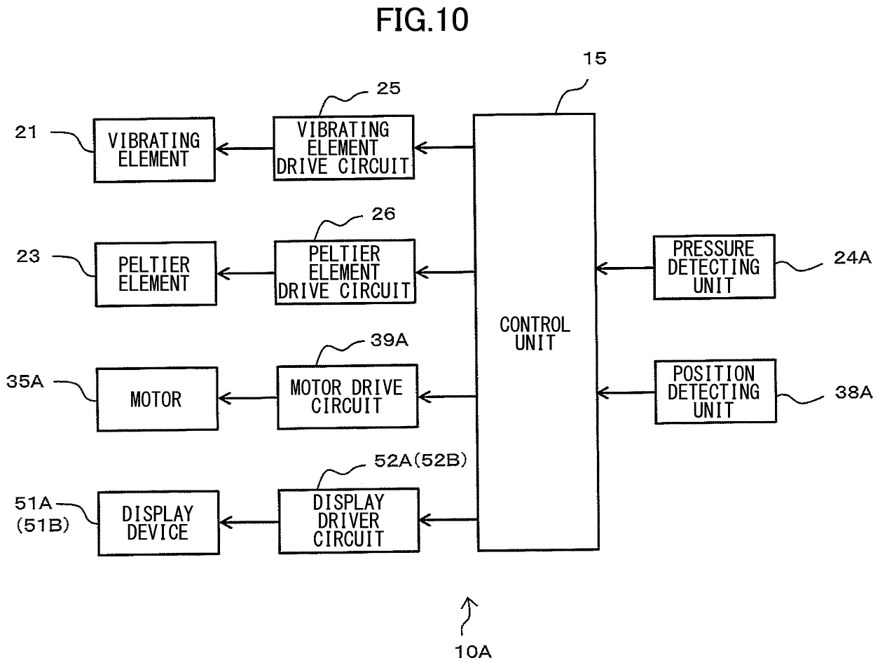

FIG. 6 is a diagram illustrating an example of first use of an input device 40 and a display device 51A according to a second embodiment, and FIG. 7 is a diagram illustrating an example of second use of input devices 40 and a display device 51B. FIG. 8A and FIG. 8B are perspective views illustrating a configuration of the input device 40 illustrated in FIG. 6 and FIG. 7. FIG. 8A is a diagram illustrating the input device 40 as viewed from above, and FIG. 8B is a diagram illustrating the input device 40 as viewed from below. FIG. 9 is an exploded perspective view illustrating a configuration of a tactile sensation presenting device 10A in the input device 40 illustrated in FIGS. 6 to 8. FIG. 10 is a functional block diagram of the tactile sensation presenting device 10A.

In the first use illustrated in FIG. 6, one input device 40 and the display device 51A are connected to each other by a code 40A and the input device 40 is operated by an operator's right hand. The display device 51A is provided with a display driver circuit 52A (FIG. 10) for driving the display device 51A, and the display driver circuit 52A is controlled by the control unit 15. The display device 51A may be a color liquid crystal display panel, an electroluminescent display panel or the like. The display device 51A may be a personal computer or a display device for demonstration having a relatively large display screen.

In the second use illustrated in FIG. 7, two input devices 40 and the display device 51B are connected to each other by codes 40B and the input devices 40 are operated by operator's right and left hands. The display device 51B is provided with a display driver circuit 52B (FIG. 10) for driving the display device 51B, and the display driver circuit 52B is controlled by the control unit 15. The display device 51B includes a mask-shaped body 511 mounted in front of operator's eyes to display a visible image and a strap 512 for mounting the mask-shaped body 511 on a head.

### Input Device Configuration

As illustrated in FIG. 8A and FIG. 8B, the input device 40 includes tactile sensation presenting devices 10A, 10B, and 10C. The respective tactile sensation presenting devices 10A, 10B, and 10C include tactile sensation generating units 20A, 20B, and 20C each of which has a configuration similar to that of the tactile sensation generating unit 20 illustrated in FIG. 1 and FIG. 2. In FIGS. 8A and 8B, tactile sensation presenting devices 10A, 10B, and 10C are pressed along the Z direction. In the configuration used as illustrated in FIG. 6 and FIG. 7, each input device 40 is held by the operator's hand with the orientation in which the Y direction of FIG. 8A and FIG. 8B is oriented vertically.

As illustrated in FIG. 8A and FIG. 8B, the input device 40 includes a case 41 made of synthetic resin. The case 41 is of a size that can be held in one hand. The case 41 is configured by combining an upper case 42 and a lower case 43. The upper case 42 and the lower case 43 can be divided in the Z direction. The upper case 42 and the lower case 43 are fixed to each other by screws or the like, and a mechanism housing space is formed in the interior of the two cases 42 and 43.

A surface of the upper case 42 oriented in the Z direction is a first surface 42a, and a surface of the lower case 43 oriented in the Z direction is a second surface 43a. Two operation holes 44A and 44B that penetrate in the Z direction are opened at the first surface 42a in the upper case 42. An operation hole 44c that penetrates the second surface 44a in the Z direction is opened in the lower case 44. The operation holes 44A and 44B are formed side-by-side in the Y direction, and the aperture dimension in the Y direction of the operation hole 44c is larger than that of the operation holes 44A and 44B of the first surface 42a. From the operation hole 44A of the first surface 42a, the tactile sensation generating unit 20A of the tactile sensation presenting device 10A and a support 33A of a pressure sensation generating unit 30A are exposed to be able to be pressed along the Z direction. In addition, from the operation hole 44B, the tactile sensation generating unit 20B of the tactile sensation presenting device 10B and a support 33B of a pressure sensation generating unit 30B are exposed to be able to be pressed along the Z direction. Further, from the operation hole 44C of the second surface 43a, the tactile sensation generating unit 20C of the tactile sensation presenting device 10C and a support 33C of a pressure sensation generating unit 30C are exposed to be able to be pressed along the Z direction. The tactile sensation generating units 20A and 20B are arranged such that the pressure detecting units 24A and 24B are on the upper side in the Z direction, and the tactile sensation generating unit 20C is arranged such that the pressure detecting unit 24C is on the lower side in the Z direction.

Here, the supports 33A, 33B, and 33C for the respective pressure sensation generating units 30A, 30B, and 30C correspond to the support 33 illustrated in FIG. 1, FIG. 3, and FIG. 4. In addition, the pressure detecting units 24A, 24B, and 24C of the tactile sensation generating units 20A, 20B, and 20C have a configuration similar to that of the pressure detecting unit 24 of the tactile sensation generating unit 20 according to the first embodiment.

Each of the tactile sensation presenting devices 10A, 10B, and 10C includes holding members similar to the holding members 11, 12, and 13 of the first embodiment. The holding members in each of the tactile sensation presenting devices 10A, 10B, and 10C have similar configurations to each other. For example, in the tactile sensation presenting device 10A, as illustrated by the broken lines in FIG. 8A, three holding members 101, 102, and 103 are sequentially arranged at a constant interval in the longitudinal direction (the illustrated Y direction) of the tactile sensation generating unit 20A having a rectangular shape in plan view, each of which extends along the width direction (the illustrated X direction) of the tactile sensation generating unit 20A in a belt-like fashion. Each of one end portion 101A of the belt-like first holding member 101 and one end portion 103A of the belt-like third holding member 103 in its longitudinal direction is fixed to the first surface 42a of the upper case 42 by adhesion or the like. The first holding member 101 and the third holding member 103 bend and extend so as to protrude upward in the Z direction and form a space with the pressure detecting unit 24A of the tactile sensation generating unit 20A. Also, one end portion 102A of the belt-like second holding member 102 is fixed to the first surface 42a. The second holding member 102 bends and extends so as to protrude upward in the Z direction and form the space with the pressure detecting unit 24A of the tactile sensation generating unit 20A.

Although not illustrated, similarly to the tactile sensation presenting device 10A, in each of the tactile sensation presenting devices 10B and 10C, three holding members are arranged. In the tactile sensation presenting device 10B, the holding members are fixed to the first surface 42a of the upper case 42, and in the tactile sensation presenting device 10C, the holding members are fixed to the second surface 43a of the lower case 43. Also, in FIG. 6, FIG. 7, and FIG. 8B, illustration of the holding members 101, 102, and 103 are omitted.

A connector mounting hole 46 is opened at the end surface oriented in the Y direction of the upper case 42, and a power plug mounting hole 47 is opened at the end surface oriented in the Y direction of the lower case 43. A signal connector 46B is exposed inside the connector mounting hole 46 such that the code 40A or the code 40B is connected. In addition, a power plug 47B is exposed inside the power plug mounting hole 47 such that a power supply line (not illustrated) is connected.

### Configuration of Tactile Sensation Presenting Device

Because the tactile sensation presenting devices 10A, 10B, and 10C have similar configurations to each other, here, only the tactile sensation presenting device 10A will be described and the description of the other tactile sensation presenting devices 10B and 10C will be omitted.

As illustrated in FIG. 9, the tactile sensation presenting device 10A includes the pressure sensation generating unit 30A and the tactile sensation generating unit 20A fixed such that the vibrating element 21 faces on the support 33A of the pressure sensation generating unit 30A. The pressure sensation generating unit 30A includes a frame 31 obtained by bending a metal plate. The frame 31 is fixed to a partition plate portion (not illustrated) within the input device 40 such that the tactile sensation presenting device 10A is contained within the input device 40.

The frame 31 is provided with a movable member 32A. The movable member 32A is formed of a synthetic resin material and the support 33A is fixed to the tip portion of the movable member 32A. The support 33A is formed of a synthetic resin material. As illustrated in FIG. 8A, the support 33A protrudes outwardly from the operational hole 44A formed in the upper case 42.

As illustrated in FIG. 9, a guide slot hole 31c extending in the Z direction is formed on one side wall portion 31a of the frame 31. A sliding protruding portion 32a is formed together on the side portion of the movable member 32A, and the sliding protruding portion 32a slides inside the guide slot hole 31c so that the movable member 32A is supported to freely move in the Z direction on the frame 31. Also, the movable member 32A has a recessed portion 32b. Inside the recessed portion 32b, a compression coil spring 34 is interposed between the movable member 32A and the lower end portion of the frame 31. By an elastic force of the compression coil spring 34, the movable member 32A is biased upwardly in the illustrated Z direction, which is a direction in which the support 33A protrudes from the upper case 42.

A motor 35A is fixed to one side wall portion 31a of the frame 31. As illustrated in FIG. 10, the motor 35A is driven by a motor drive circuit 39A based on a control signal from the control unit 15.

An output gear 36a is fixed to the output shaft of the motor 35A. A reduction gear 36b is rotatably supported on the outer surface of the side wall portion 31a, and the output gear 36a meshes with the reduction gear 36b. A gearbox 37 is fixed to the side wall portion 31a of the frame 31 and a reduction mechanism is contained in the gearbox 37. A rotational force of the reduction gear 36b is reduced by the reduction mechanism in the gear box 37. The reduction mechanism in the gear box 37 is composed of gears such as a sun gear and a planetary gear.

A pinion gear 37a is fixed to the reduction output shaft of the gear box 37. A rack portion 32c is formed on the surface of a thick portion of the movable member 32A, and the pinion gear 37a meshes with the rack portion 32c. The tooth portion of the pinion gear 37a and the tooth portion of the rack portion 32c are helical gear teeth inclined with respect to the Y direction perpendicular to the moving direction of the movable member 32A. By providing the compression coil spring 34, the backlash between the pinion gear 37a and the rack portion 32c can be eliminated. Note that the compression coil spring 34 may be omitted.

In this embodiment, the motor 35A, the output gear 36a, the reduction gear 36b, the gearbox 37, the pinion gear 37a, and the rack portion 32c constitute a front/back drive unit, and by driving the motor 35A to move the support 33A vertically, the tactile sensation presentation surface of the pressure detecting unit 24A can be moved vertically along the illustrated Z direction.

A position detecting unit 38A is fixed to the other side wall portion 31b of the frame 31. The position detecting unit 38A includes a stator portion (not illustrated) fixed to the side wall portion 31b and a rotor portion (not illustrated) that rotates facing the stator portion. A rotor shaft provided in the rotor portion rotates together with the pinion gear 37a. The position detecting unit 38A is of a resistance-change type, and a circular arc-shaped resistor pattern is provided on the stator portion, and a slider that slides the resistor pattern is provided on the rotor portion. The position detecting unit 38A is connected to the control unit 15, and in the control unit 15, a position of the tactile sensation presentation surface on the pressure detecting unit 24A of the tactile sensation generating unit 20A fixed on the support 33A is calculated based on the detection result.

Note that the position detecting unit 38A may be of a magnetic detection type, and a rotating magnet may be fixed to a rotor portion, and a magnetic detection element such as a GMR element may be provided on a stator portion, and a rotation angle of the rotor portion may be detected by the magnetic detection element. Alternatively, the position detecting unit 38A may be an optical position detecting unit.

As illustrated in FIG. 8A and FIG. 8B, the tactile sensation generating unit 20A is fixed to the upper surface of the first support 33A, the second tactile sensation generating unit 20B is fixed to the upper surface of the second support 33B, and the third tactile sensation generating unit 20C is fixed to the bottom surface of the third support 33C.

In the pressure sensation generating unit 30A, by controlling the rotation of the motor 35A, it is possible to move the movable member 32A to a desired position and stop the movable member 32A at the desired position. For example, it is possible to stop the support 33A at the position where the support 33A maximally protrudes from the case 41, or it is possible to stop the support 33A at the position where the support 33A maximally retracts in the case 41. In addition, it is also possible to stop the support 33A at a desired position between the maximum protruding position and the maximum retracting position. Accordingly, the pressure sensation generating unit 30A, which serves as a displacing unit, can vertically displace the tactile sensation presentation surface. Thereby, it is possible to provide pressure information to the tactile sensation generating unit 20A fixed on the support 33A and to present the pressure information on the pressure detecting unit 24A as the tactile sensation presentation surface.

Also, by controlling electric power applied to the motor 35A, the rotor of the motor 35A can be maintained by a strong force so that the support 33A protruding from the case 41 is not moved even being pushed by a finger.

Furthermore, it is preferable that a vertical movement of the support 33A by rotation of the motor 35A is performed at a frequency and amplitude (displacement amount) different from those of vibration by the vibrating element 21. For example, by causing the vibrating element 21 to generate vibration information at a frequency of three times the frequency of a vertical movement of the support 33A and at the same time, by making the amplitude of the vibration generated by the vibrating element 21 1/10 of the displacement amount of the support 33A, a finer tactile sensation can be presented.

When the movable member 32A is in a movable state, upon the support 33A being pushed such that the movable member 32A moves in the push direction, the movement position is detected by the position detecting unit 38A and the detection output is applied to the control unit 15. The control unit 15 holds data on a reaction force action line (reaction force action coefficient) indicating the relationship between the movement distance and the reaction force for reaction force application control, and the motor 35A is controlled to generate a torque corresponding to the reaction force action line in accordance with the push position of the support 33A. Thereby, a reaction force is applied to the finger pressing the support 33A.

As illustrated in FIG. 10, a detection result by the pressure detecting unit 24A is output to the control unit 15. Based on the detection result, the control unit 15 (1) applies a control signal to the vibrating element drive circuit 25 for presenting vibration information; (2) applies a control signal to the Peltier element drive circuit 26 for presenting warm/cold information; (3) applies a control signal to the motor drive circuit 39A to operate the motor 35A of the pressure sensation generating unit 30A; and (4) applies a control signal to the display driver circuits 52A and 52B for causing the display devices 51A and 51B to display an image corresponding to the detection result. As a result, a tactile sensation including the vibration information generated by driving the vibrating element 21, the warm/cold information generated by the Peltier element 23, and the pressure information generated by driving the motor 35A is presented to a finger contacting the pressure detecting unit 24A, and also the image corresponding to an operation of the finger as an operator part is displayed on the display devices 51A and 51B.

Here, the control unit 15 as an adjusting unit adjusts, based on the detection result by the pressure detecting unit 24A, the pressure applied to the finger as an operating part contacting the tactile sensation presentation surface as a presentation condition of the tactile sensation. More specifically, for a case in which the contact pressure of a finger with respect to the pressure detecting unit 24A is within a predetermined range and for a case in which the contact pressure exceeds the predetermined range, the driving conditions of the motor 35A are changed to differ the pressure information presented to the tactile sensation presentation surface, such that the contact pressure of the finger with respect to the tactile sensation presentation surface is adjusted. Also, in a case in which the contact pressure is below the predetermined range, the control unit 15 may cause pressure information, which is different from that of the case in which the contact pressure is within the predetermined range and that of the case in which the contact pressure exceeds the predetermined range, to be presented, or may alert the operator to increase the contact pressure. By such adjustments, it is possible to maintain a constant tactile sensation presented to an operator, even when the contact pressure differs. Alternatively, by changing the tactile sensation in accordance with the contact pressure, for example, it is possible to realistically present a virtual tactile sensation.

Further, similarly to the first embodiment, the control unit 15 may adjust, as a presentation condition of the tactile sensation, at least one of the vibration information and the warm/cold information based on the detection result by the pressure detecting unit 24A. In this way, in addition to pressure information, by a tactile sensation including vibration information and warm/cold information, it is possible to present a more realistic tactile sensation in accordance with the contact pressure of a finger.

Although the motor 35A is driven to vertically displace the tactile sensation generating unit 20A in order to adjust a pressure applied to a finger as an operating part in the second embodiment, the tactile sensation generating unit 20A may be displaced by other means. For example, an air cylinder or a hydraulic or piezoelectric actuator may be used for displacement.

Note that other functions, effects, and modifications are similar to those in the first embodiment.

Although the present invention has been described with reference to the above described embodiments, the present invention is not limited to the above described embodiments. Various enhancements or changes can be made within the scope of the present invention.

### INDUSTRIAL APPLICABILITY

As described above, a tactile sensation presenting device according to an aspect of the present invention is useful in that it is possible to present an optimum tactile sensation in accordance with a contact state of an operating part with respect to a tactile sensation presentation surface.

What is claimed is:

1. A tactile sensation presenting device comprising:
a vibrating element configured to present vibration information;
a warmth/coldness presenting element provided above the vibrating element and configured to present warm/cold information to a tactile sensation presentation surface;
a pressure detecting unit configured to detect a pressure corresponding to a contact state of an operating part with respect to the tactile sensation presentation surface; and
an adjusting unit configured to adjust a presentation condition based on a detection result by the pressure detecting unit.

2. The tactile sensation presenting device according to claim 1, wherein the adjusting unit adjusts, as the presentation condition, at least one of the vibration information and the warm/cold information.

3. The tactile sensation presenting device according to claim 2, wherein the pressure detecting unit is provided on the tactile sensation presentation surface and detects the pressure received by the tactile sensation presentation surface from the operating part.

4. The tactile sensation presenting device according to claim 2 further comprising:
a holding member configured to hold the operating part so as to maintain the contact state with respect to the tactile sensation presentation surface,
wherein the pressure detecting unit is provided on a contact surface where the holding member contacts the operating part, and detects a pressure received by the contact surface from the operating part.

5. The tactile sensation presenting device according to claim 1, wherein the adjusting unit adjusts, as the presentation condition, a pressure applied to the operating part contacting the tactile sensation presentation surface.

6. The tactile sensation presenting device according to claim 5, further comprising:
a holding member configured to hold the operating part so as to maintain the contact state with respect to the tactile sensation presentation surface; and
a displacing unit configured to displace the tactile sensation presentation surface,
wherein the adjusting unit causes the displacing unit to displace the tactile sensation presentation surface based on the detection result by the pressure detecting unit in order to adjust the pressure applied to the operating part held by the holding member.

7. The tactile sensation presenting device according to claim 1, wherein the pressure detecting unit is an electrostatic detecting unit configured to detect the pressure by a change in electrostatic capacity.

8. The tactile sensation presenting device according to claim 1, wherein the pressure detecting unit is a resistance type detecting unit configured to detect the pressure by a change in resistance value.
